(19) United States
(12) Patent Application Publication
(10) Pub. No.: US 2011/0210058 A1
(43) Pub. Date: Sep. 1, 2011

(54) SYSTEM AND METHOD OF SELF-ADJUSTING SCREEN CLAMP

(75) Inventor: Ari M. Hukki, Boynton Beach, FL (US)

(73) Assignee: CPI Wirecloth & Screens, Inc., Pearland, TX (US)

(21) Appl. No.: 13/093,079

(22) Filed: Apr. 25, 2011

Related U.S. Application Data
(63) Continuation-in-part of application No. 12/772,859, filed on May 3, 2010.
(60) Provisional application No. 61/215,092, filed on May 1, 2009.

(51) Int. Cl. B01D 35/28; B23P 17/04

(52) U.S. Cl. 210/232; 29/428

(57) ABSTRACT

A system and method allow for the installation and removal of curved screen elements from a shaker table. Pneumatic cylinders are used to move hold down bars either up to allow for screen elements to be installed or removed from the screen bed section assembly, or down to clamp screen elements into the screen bed section assembly of a shaker so that the screen elements will not move during shaker operations. Each curved screen element may have a different radius. Self-adjusting hold down bars compensate for adjacent screen elements having edges that are parallel but at different elevations. The self-adjusting hold down bars also compensate for adjacent screen elements having edges that are not parallel.

### CROSS-REFERENCE TO RELATED APPLICATIONS

This application is a continuation-in-part of co-pending U.S. application Ser. No. 12/772,859 filed on May 3, 2010, which claims the benefit of U.S. Provisional Application No. 61/215,092 filed on May 1, 2009, both of which applications are hereby incorporated by reference for all purposes in their entirety.

### STATEMENT REGARDING FEDERALLY-SPONSORED RESEARCH OR DEVELOPMENT

N/A

### NAMES OF THE PARTIES TO A JOINT RESEARCH AGREEMENT

N/A

### REFERENCE TO MICROFICHE APPENDIX

N/A

### BACKGROUND OF THE INVENTION

1. Field of the Invention

This invention relates to screens for vibratory machinery and more particularly to shake table screening.

2. Description of the Related Art

Shaker tables are well known to filter solids from liquids in the oil, gas & petroleum industry. Screen elements are used to filter the solids from the liquids; however, they must be replaced periodically when they become clogged with solids or wear down. Easy installation and removal of the screen elements is hard to achieve. The typical practice is to install and remove the screen elements manually, which can be difficult to accomplish, and interrupts filtering operations for an extended period of time. Thus, there is a need for a method and apparatus that allows for the easy installation and removal of screen elements in a shake table. Unfortunately, such a method and apparatus has not been available to date.

### BRIEF SUMMARY OF INVENTION

A system and method are provided to install and remove multiple curved screen elements used for filtering solids from liquids in a shaker table. The apparatus is comprised of a set of hold down bars that are guided through a carrier frame. The carrier frame holds multiple curved screen elements. The hold down bars are connected to a carrier frame mounting bracket. This entire assembly sits on a screen bed that houses pneumatic cylinders. In addition to the carrier frame mounting bracket being connected to the hold down bars, it is also connected to the pistons of the pneumatic cylinder heads located in the screen bed. When the pneumatic cylinders are actuated such that the pistons move upward, the hold down bars are pushed upward allowing the curved screen elements to be easily installed or removed by sliding them into or out of the carrier frame. When the pneumatic cylinders are actuated such that the pistons are in a downward position, the hold down bars clamp the screen elements in place in the carrier frame, thus forming a screen clamp. No tools are required to install or remove the curved screen elements.

Each curved screen element may have a different radius, so that each curved screen element resting on the carrier frame may have an edge that is at a different elevation than the edge of an adjacent curved screen element. The edges of the adjacent screen elements may be parallel or not. In one embodiment, each hold down bar is self-adjusting to compensate for the differences between the edges of the two screen elements adjacent to the hold down bar that are resting on the carrier frame. The hold down bar is adjusted by the adjacent screen elements. Each self-adjusting hold down bar includes a pair of metal plate sections each of which has a respective opposed hold down bar ledge that is configured to contact an edge of a curved screen element and hold the screen element in place against the carrier frame when the hold down bar is in the closed or downward position.

A pair of bolt brackets each have a pair of bolt bracket bolts disposed through aligned openings in both metal plate sections of the self-adjusting hold down bar. Each bolt bracket bolt may extend through an opening in the first metal plate section of the hold down bar that is a different size than the aligned opening in the second metal plate section. A locking hex nut may be disposed on the end of the bolt bracket bolt. The bolt bracket allows the pair of plate sections of the hold down bar to move relative to each other to self-adjust and accommodate curved screen elements having edges that are parallel but at different elevations or that are not parallel. Two self-adjusting hold down bars may be connected with each other with two tube brackets and connected with the carrier frame mounting bracket.

### BRIEF DESCRIPTION OF THE DRAWINGS

A better understanding of the embodiments may be obtained with the following detailed descriptions of the various disclosed embodiments in the drawings, which are given by way of illustration only, and thus are not limiting the invention, and wherein:

FIG. 1 is an isometric view of an assembled shaker;

FIG. 2 is an isometric exploded view of a shaker assembly;

FIG. 3 is an isometric exploded view of a screen bed assembly;

FIG. 4 is a cross sectional view of a closed screen bed assembly;

FIG. 5 is across sectional view of a screen bed assembly with hold down bars in an upward position for screen element removal;

FIG. 6 is across sectional view of a screen bed assembly with hold down bars in an upward position and with a screen element moved away from the carrier frame;

FIG. 7 is an isometric exploded view of a screen element assembly;

FIG. 8 is an isometric view of a hold down bar;

FIG. 9 is an isometric view of a carrier frame;

FIG. 10 is an isometric view of a hold down bar guide;

FIG. 11 is an isometric view of a carrier frame with screen elements;

FIG. 12 is an isometric view of a screen carrier with screen elements removed;

FIG. 13 is an isometric view of a screen element support bar;

FIG. 14 is an isometric view of a screen carrier mounting bracket;

FIG. 15 is an isometric exploded view of a portion of a screen carrier mounting bracket;

FIG. 16 is an isometric exploded view of a clamp plate assembly in a screen carrier mounting bracket;

FIG. 17 is an isometric view of a screen bed;

FIG. 18 is an isometric view of a portion of a screen bed section;

FIG. 19 is an isometric view of a pneumatic cylinder;

FIG. 20 is an isometric exploded view of a plurality of self-adjusting hold down bars, a plurality of screen elements, a carrier frame, a screen carrier mounting bracket, a screen bed section, and two pneumatic cylinders;

FIG. 21 is an isometric exploded view of a plurality of self-adjusting hold down bars, a plurality of tube brackets, and a screen carrier mounting bracket;

FIG. 22 is an isometric exploded view of a self-adjusting hold down bar having a first metal plate section and a second metal plate, two bolt brackets, and four hex nuts;

FIG. 23 is an isometric exploded view of two self-adjusting hold down bars each having a first section and a second section, four bolt brackets, two tube brackets and two tube bracket bolts;

FIG. 24 is an elevational view of a self-adjusting hold down bar that is compensating for two adjacent screen elements (not shown) with edges that are parallel but at different elevations;

FIG. 24A is a detail view of detail area 24A of FIG. 24;

FIG. 24B is a detail view of detail area 24B of FIG. 24;

FIG. 24C is an end view along line 24C-24C of FIG. 24;

FIG. 25 is an opposite side elevational view of the self-adjusting hold down bar of FIG. 24;

FIG. 25A is a detail view of detail area 25A of FIG. 25;

FIG. 25B is a detail view of detail area 25B of FIG. 25;

FIG. 26 is an elevational view of a self-adjusting hold down bar that is compensating for two adjacent screen elements (not shown) with edges that are not parallel;

FIG. 26A is a detail view of detail area 26A of FIG. 26;

FIG. 26B is a detail view of detail area 26B of FIG. 26;

FIG. 26C is an end view along line 26C-26C of FIG. 26;

FIG. 27 is an opposite side elevational view of the self-adjusting hold down bar of FIG. 26;

FIG. 27A is a detail view of detail area 27A of FIG. 27;

FIG. 27B is a detail view of detail area 27B of FIG. 27;

FIG. 28 is a cross sectional view of a screen bed assembly with the self-adjusting hold down bars in the closed or downward position;

FIG. 29 is a cross sectional view of a screen bed assembly with the self-adjusting hold down bars in the open or upward position for screen element removal; and

FIG. 30 is a cross sectional view of a screen bed assembly with a screen element moved away from the carrier frame.

### DETAILED DESCRIPTION OF THE INVENTION

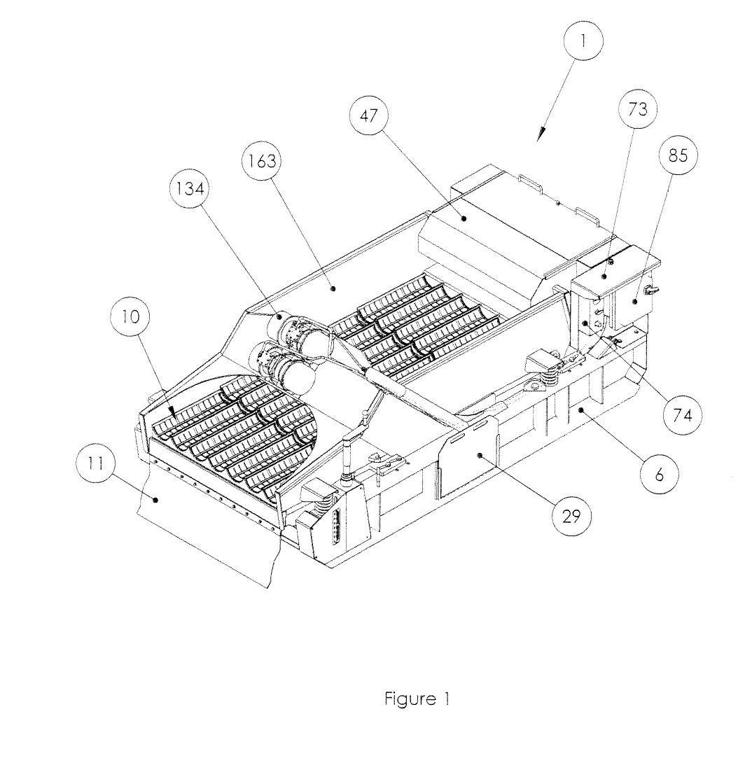

A depiction of the general assembly of a shaker 1 that is used with the apparatus and method of this invention can be seen in FIG. 1. The shaker 1 is comprised of a shaker base assembly 6, which provides a base in which a screen carrier assembly 10, shaker basket assembly 163 and feed box assembly 47 sits. In general, drilling mud is fed into the feed box assembly 47, which goes into a shaker basket assembly 163. The shaker basket assembly 163 contains a screen carrier assembly 10, which serves as a filter for the drilling mud. At least one motion generator 134 provides shaking motion to the shaker basket assembly 163. Any solids in the drilling mud are separated by the drilling mud moving through the screen carrier assembly 10. The strained drilling mud is discharged at the discharge port 29, and any solids removed from the drilling mud travels forward on top of the screen carrier assembly 10 and will be discharged over the discharge skirt 11.

Hold down bars 40 are pneumatically operated so that the screen elements 45 can be easily installed or removed in the screen carrier assembly 10. In order to operate the pneumatic controls, a control panel support stand 73 is mounted to the side of the shaker 1. An electrical control panel 85 is then attached to the control panel support stand 73. The control panel support stand 73 contains a pneumatic control panel 74, which pneumatically controls the operation of the screen carrier assembly 10.

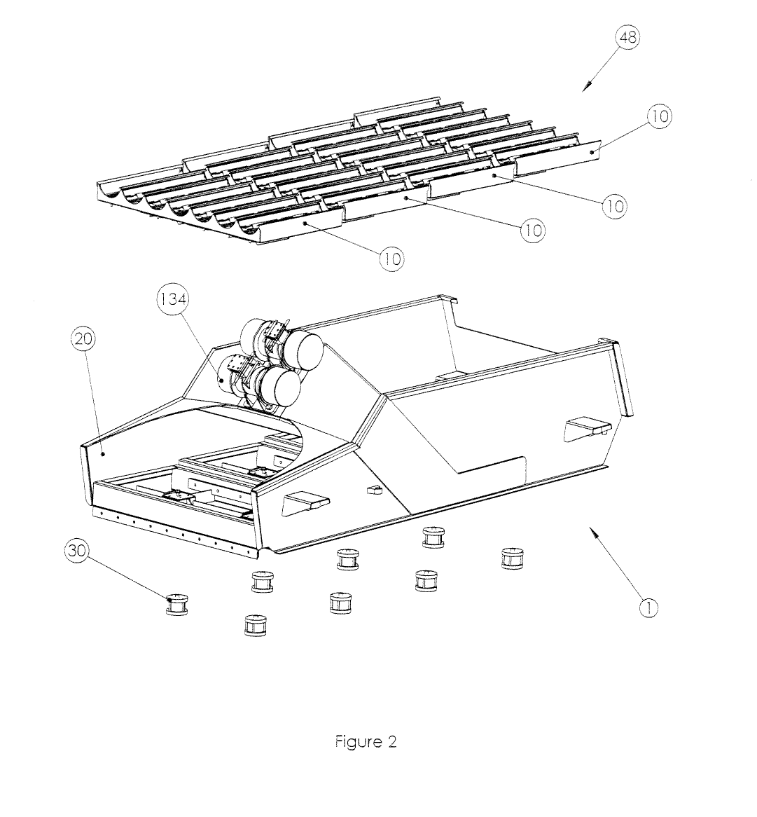

FIG. 2 depicts an exploded view of a shaker 1. Multiple screen carrier assemblies 10 comprise a screen carrier section assembly 48, which is set inside the shaker 1. Each screen carrier section 10 is set inside a screen deck assembly 20 within the shaker 1, and is operated pneumatically. Each screen carrier section 10 is ideally operated by two pneumatic cylinders 30, which are operated at the pneumatic control panel 74.

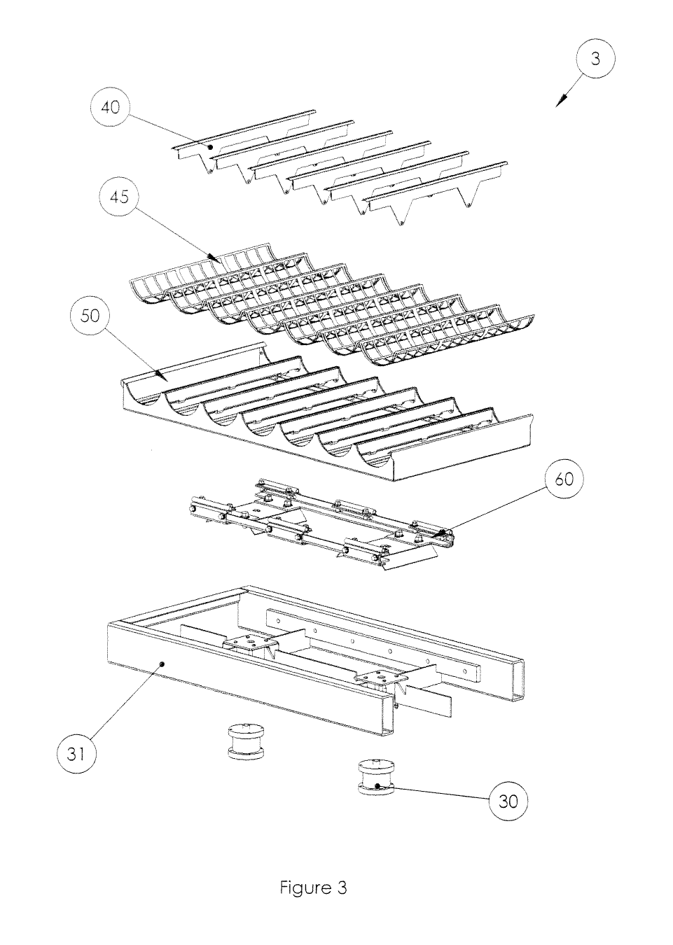

An exploded screen bed section assembly 3 is depicted in FIG. 3. Multiple screen bed section assemblies 3 sit one after the other inside the shaker 1, and on top of the shaker base assembly 6 as shown in FIG. 1. In FIG. 3, a screen bed section 3 is comprised of a screen bed 31 and an area to house one or more pneumatic cylinders 30. The screen bed section 3 forms the base of the assembly 3. Preferably two pneumatic cylinders 30 are connected to each screen bed section 31. A carrier frame mounting bracket assembly 60 is attached to the screen bed section 31 at the pneumatic cylinder 30 locations. The carrier frame mounting bracket assembly 60 is sandwiched between the carrier frame 50 and the screen bed 31, with the carrier frame 50 sitting on the screen bed 31. Hold down bars 40 are inserted through the carrier frame 50 and bolted to the carrier frame mounting bracket assembly 60. When the hold down bars 40 are lifted to an upward position, curved screen elements 45 can be slid in and out of the carrier frame 50. After the screen elements 45 are placed inside the carrier frame 50, the hold down bars 40 can be lowered to clamp the screen elements 45 in place.

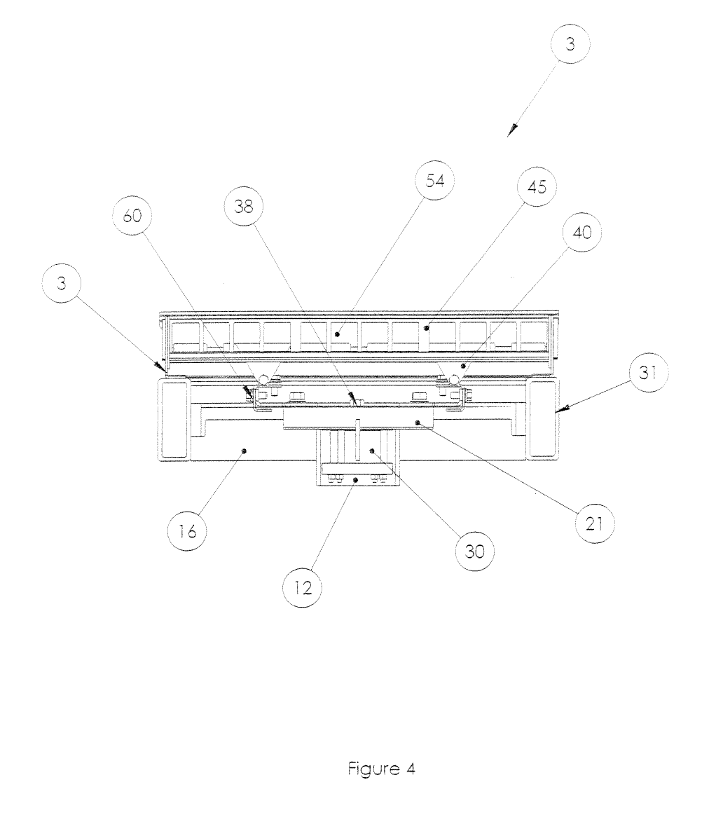

FIG. 4 shows a cross sectional view of the screen bed assembly section 3 when the hold down bars 40 are in a closed position. In FIG. 4, the screen bed section 31 contains pneumatic cylinder holder cups 12, which house pneumatic cylinders 30. The pneumatic cylinder holder cups 12 are supported and connected to the screen bed section 31 by pneumatic cylinder holder support brackets 16. The carrier frame mounting bracket assembly 60 attaches to the screen bed section 31 by bolting a clamp plate 21 to the piston 38 of a pneumatic cylinder 30. The carrier frame mounting bracket assembly 60 is then bolted to the hold down bars 40, which are slid through guides 54 located between each screen element 45 in the carrier frame 50. The carrier frame 50 sits between the screen bed section 31 and the screen elements 45 that are clamped down by the hold down bars 40. FIG. 4 shows that the carrier frame front scallop plate 2 sits on the screen bed section 31, and is also locked into place by the hold down bars 40.

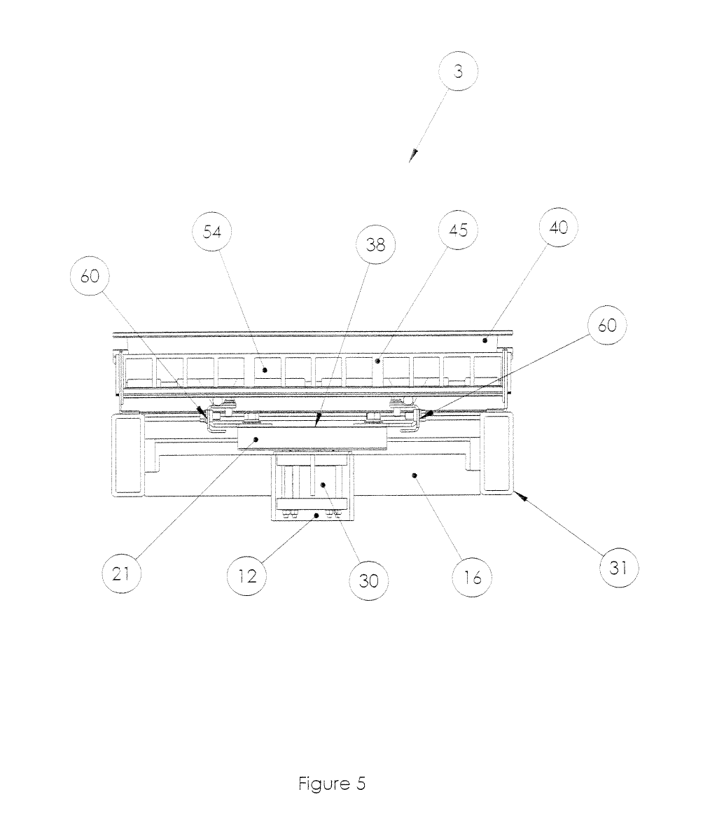

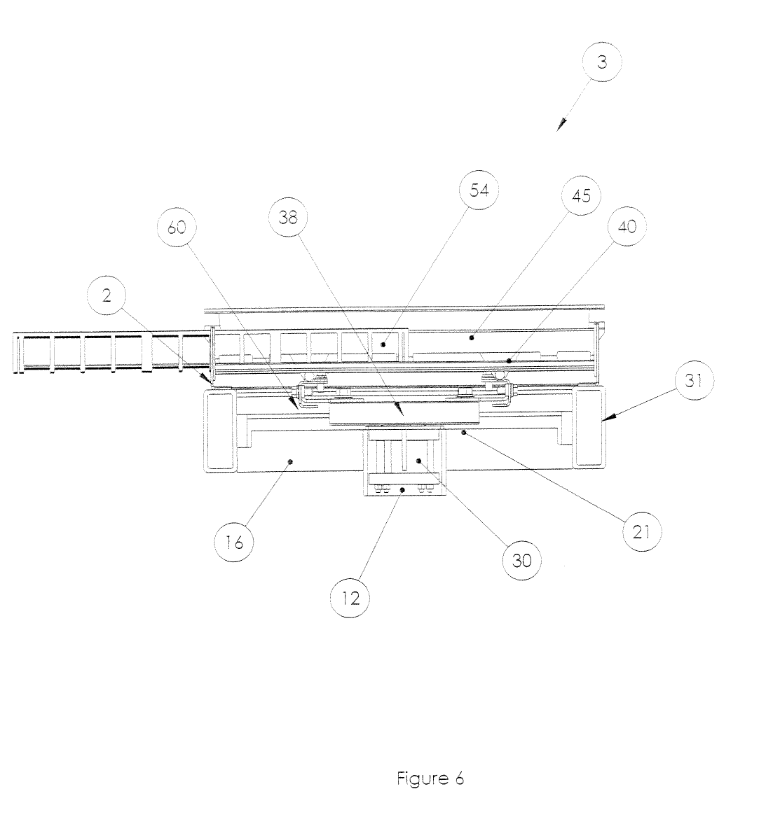

FIG. 5 is similar to FIG. 4, except that the hold down bar 40 is in an upward position. The hold down bar 40 is placed in an upward position when the pneumatic cylinder piston 38 of the pneumatic cylinder 30 is actuated and extends upward. When the hold down bar 40 is in an upward position, the screen elements 45 can easily be installed or removed. FIG. 6 shows the screen element 45 as it is moved either into or out of the screen bed assembly.

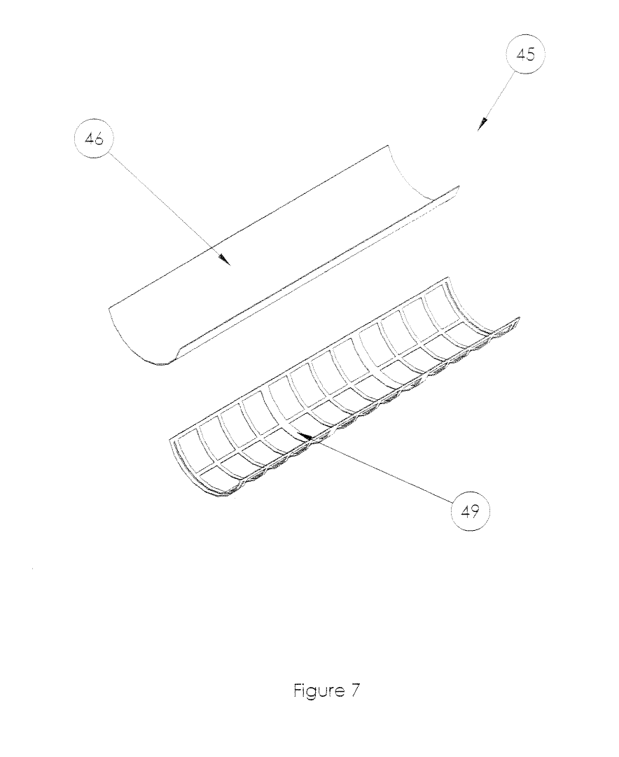

FIG. 7 shows a detailed view of a screen element 45. The screen element 45 is comprised of a curved webbed filter 49, preferably including stamped metal, which is then preferably coated with an epoxy powder coating. A mesh screen 46, preferably made of wire cloth, is placed on top of the filter 49, and heated in a heat press until the mesh screen 46 is affixed to the filter 49 and forms the individual screen elements 45.

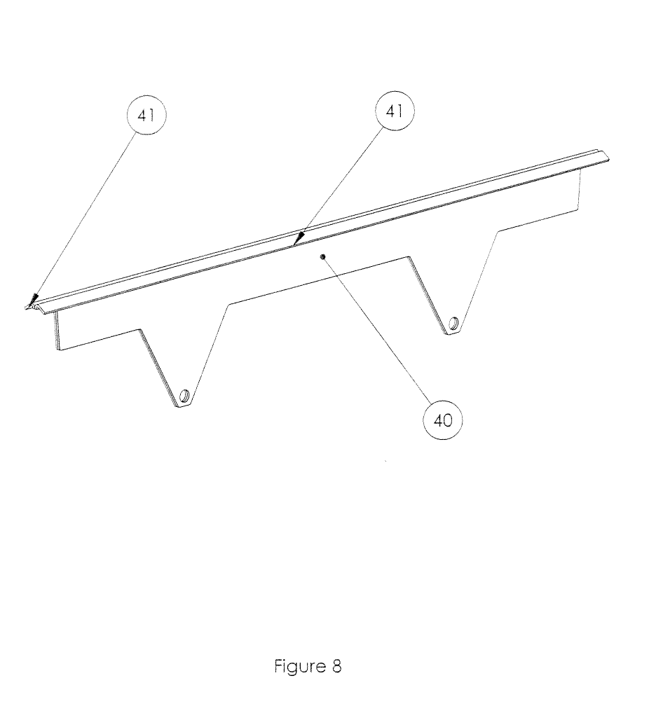

FIG. 8 shows a detailed view of a hold down bar 40. Two metal plates, each with its own ledge 41, are welded together to form a hold down bar 40. The hold down ledges 41 serve to clamp the screen elements 45 in place when the hold down bar 40 is in a closed position.

FIG. 9 is a detailed view of a carrier frame 50. Each carrier frame includes, for example, two carrier frame side plates 5 and two carrier frame scallop plates 2, which are welded together to form a frame. The carrier frame 50 sits on top of the screen bed 31, and supports the screen elements 45. To better support the screen elements 45, screen element support bars 52, preferably two, are welded beneath each scallop in the scallop plates 2 where the curved portion of the screen element 45 will rest. In between where each screen element 45 will rest, a hold down bar guide 54 is welded to the carrier frame 50. The hold down bar guide 54 provides the location where the hold down bars 40 will move up and down through the carrier frame 50. As discussed previously, when the hold down bars 40 are in an upward position, screen elements 45 can be easily installed and removed. However, when the hold down bars 40 are in a lowered position through the hold down bar guide 54, the hold down bar ledges 41 will clamp the screen elements 45 into the carrier frame 50.

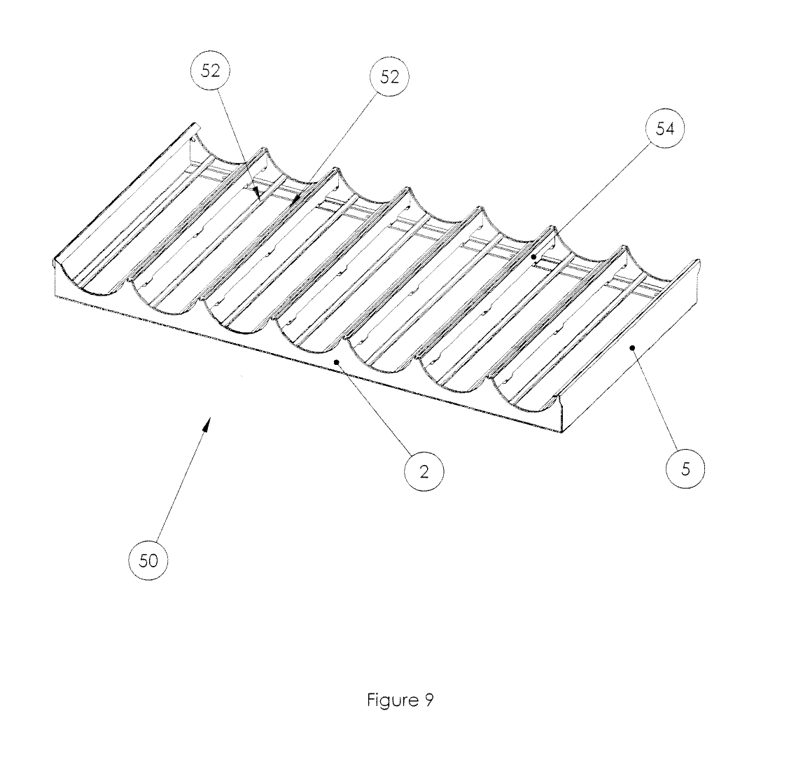

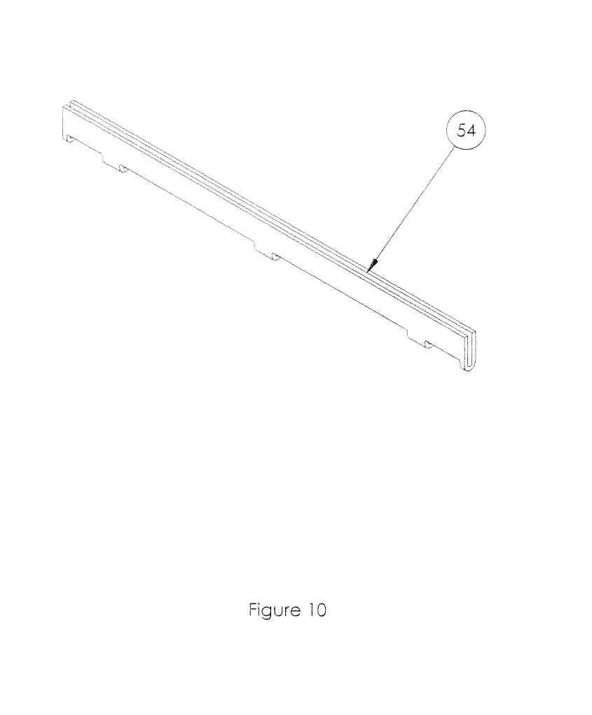

FIG. 10 is a detailed view of the hold down bar guide 54, which is placed between each scallop in the scallop plates 2 of the carrier frame 50. The hold down bar guide 54 is preferably a u-shaped piece of metal with channels cut so that the hold down bars 40 can slip through the hold down bar guide 54 and connect to the carrier frame mounting bracket assembly 60.

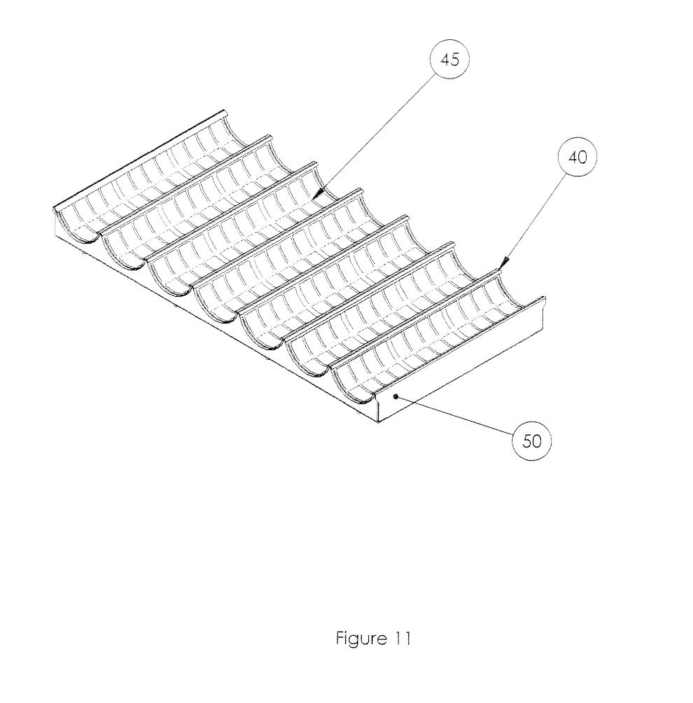

FIG. 11 depicts the carrier frame 50 when the screen elements 45 are in place, and the hold down bars 40 are in the closed position.

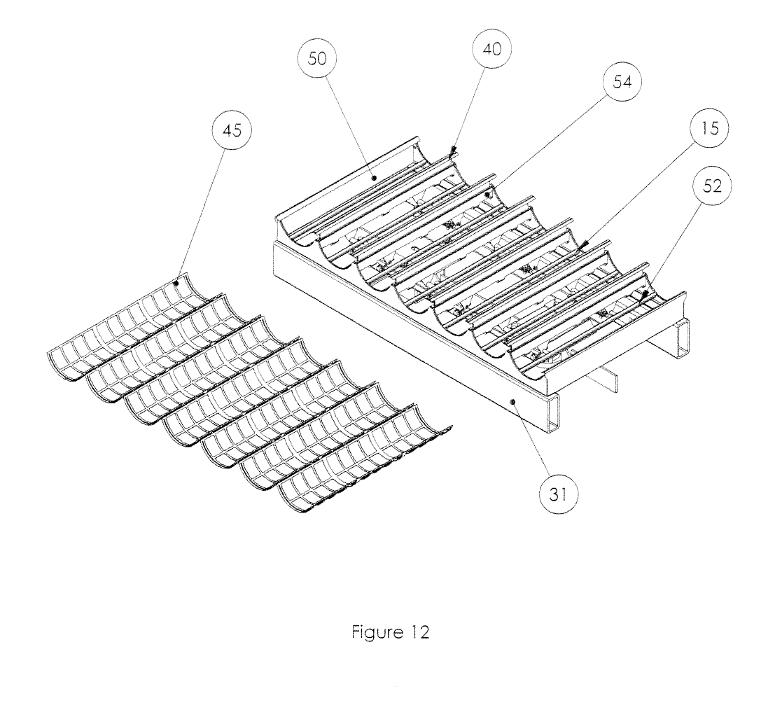

FIG. 12 shows another view of the screen bed section assembly 3 with the screen elements 45 removed.

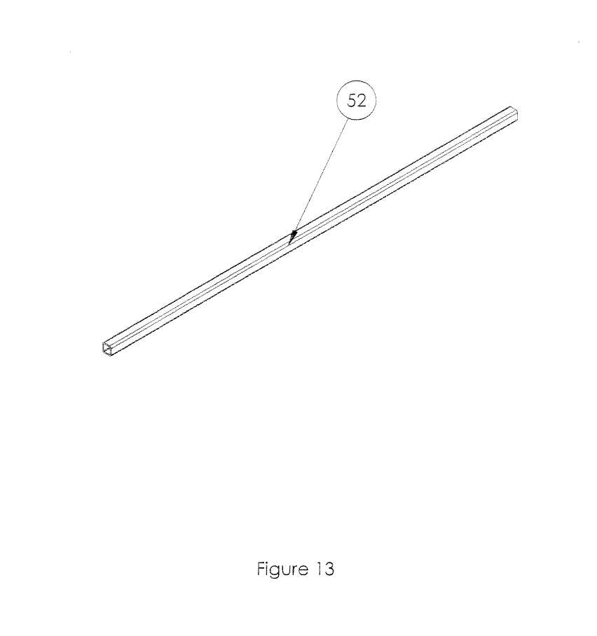

FIG. 13 is a detailed view of the screen element support bar 52, which sits at the bottom of each scallop in the scallop plates 2 of the carrier frame 50. The screen element support bar 52 is preferably metal, and preferably welded to the carrier frame 50. The use of two screen element support bars 52 is preferred to support each screen element 45 in the carrier frame 50.

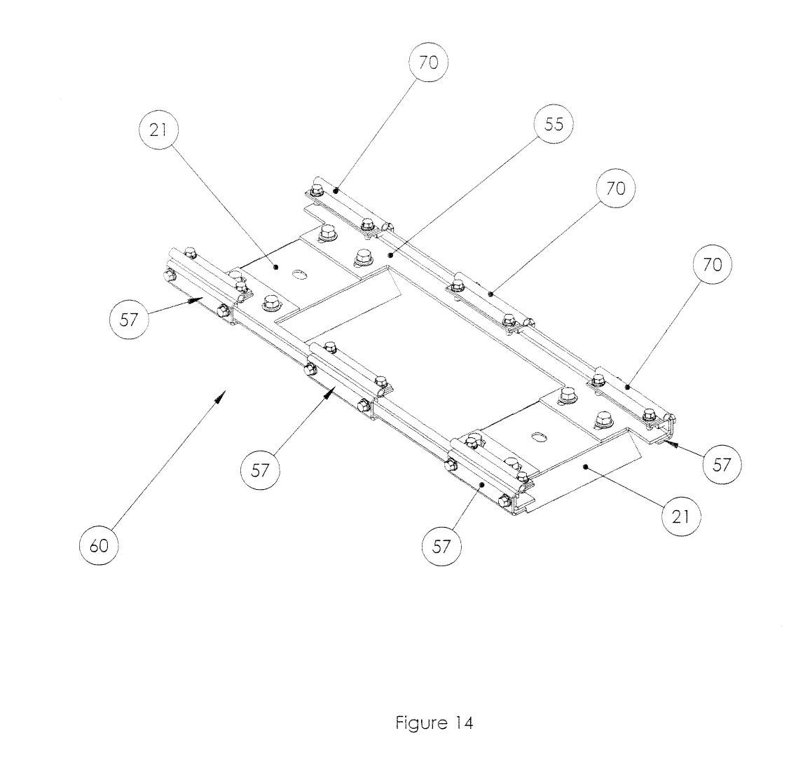

FIG. 14 is a detailed view of the screen carrier mounting bracket 60. Two mounting bracket supports 55 are connected by two clamp plates 21. The preferable means of connection is by bolting the pieces together, although these pieces of the screen carrier mounting bracket 60 could be one continuous piece or could be connected by weld. Tube brackets 70 are affixed to a tube bracket adaptor 57, which is in turn attached to each mounting bracket support 55. Preferably, each tube bracket 70 and tube bracket adaptor 57 is metal, and each is attached to the respective component by bolting the components together. However, it is envisioned that these components could be attached by other means known in the art.

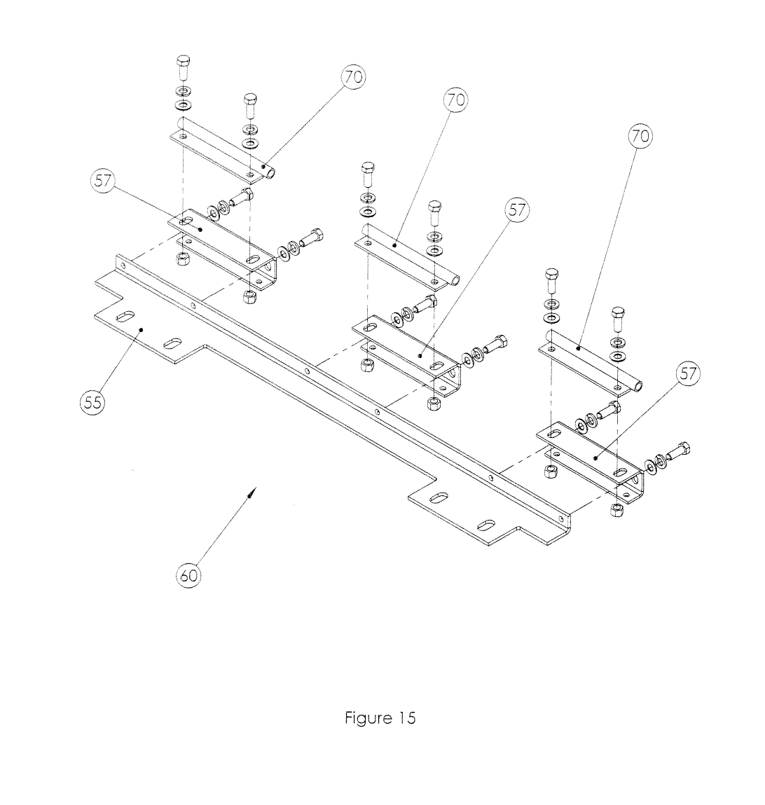

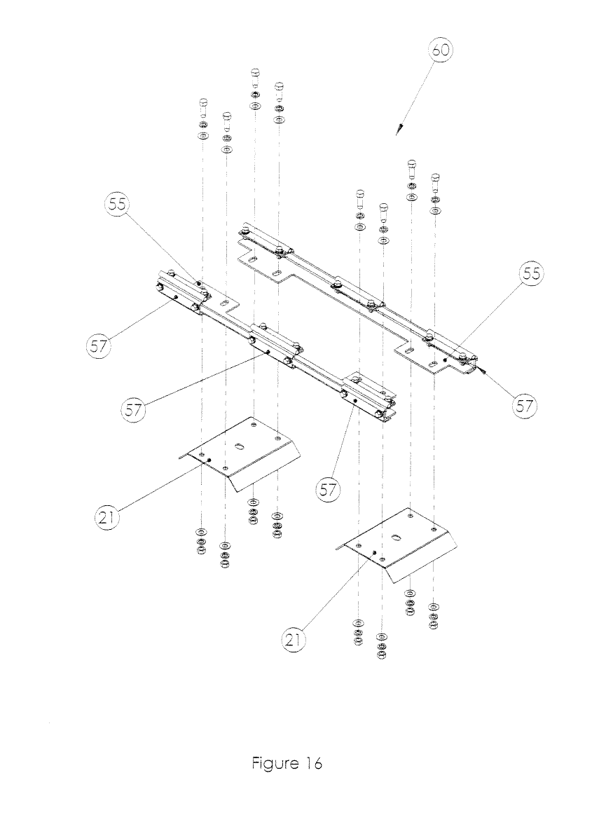

FIG. 15 is an exploded view of the screen carrier mounting bracket 60 and shows the preferred embodiment of bolting tube bracket adapters 57 to the mounting bracket support 55, and mounting tube brackets 70 to the tube bracket adaptors 57. FIG. 16 is another exploded view of the screen carrier mounting bracket 60 that shows the preferred embodiment of bolting the clamp plates 21 to the mounting bracket support 55.

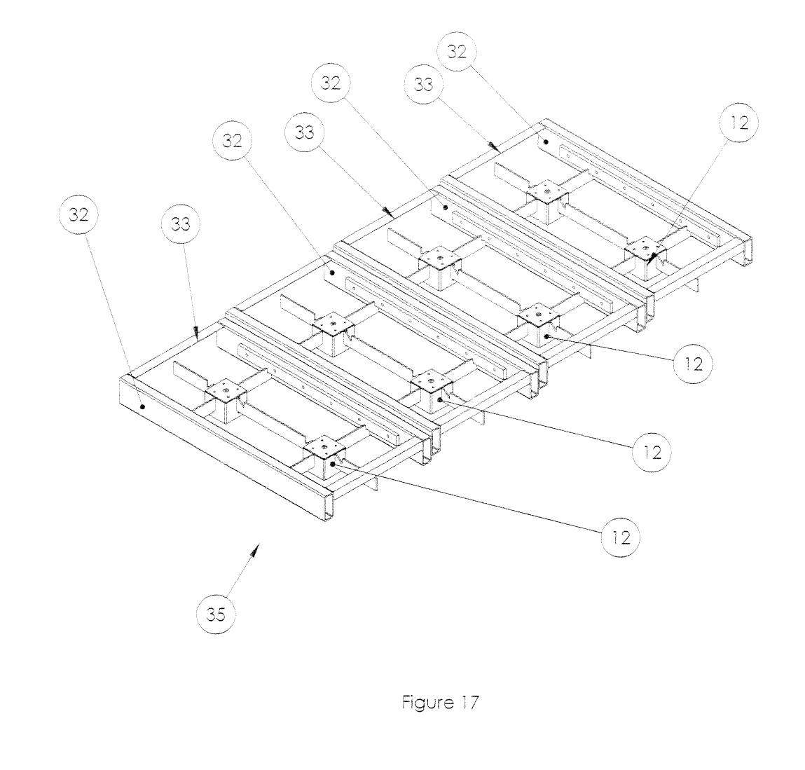

The clamp plates 21 sit on the pneumatic cylinder cup holders 4 shown in FIG. 17. Each clamp plate 21 is bolted to the pneumatic cylinder piston 38 which is centered inside the pneumatic cylinder cup holder 4. The hold down bars 40 are bolted to the ends of the tube brackets 70 of the carrier frame mounting bracket assembly 60.

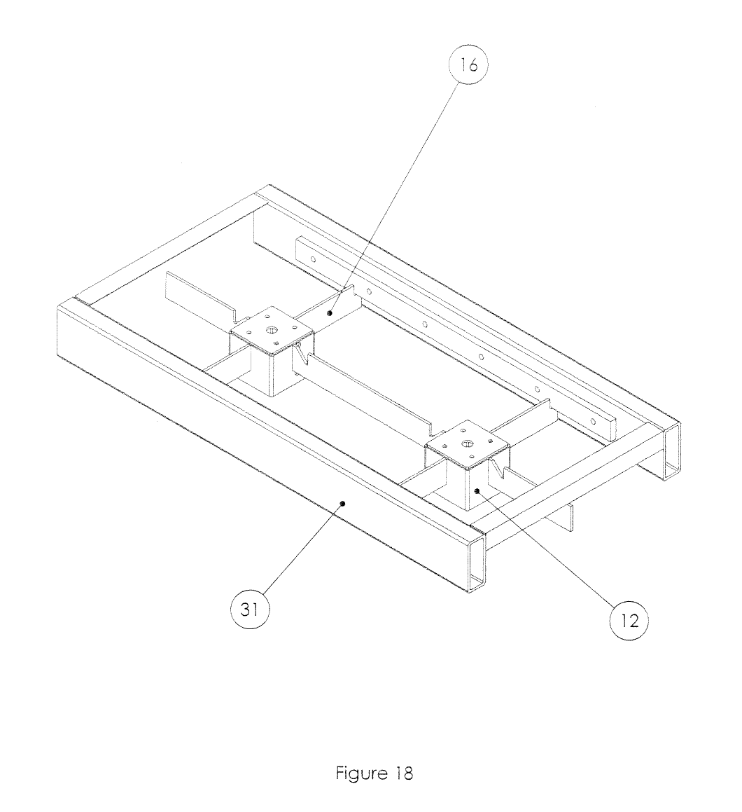

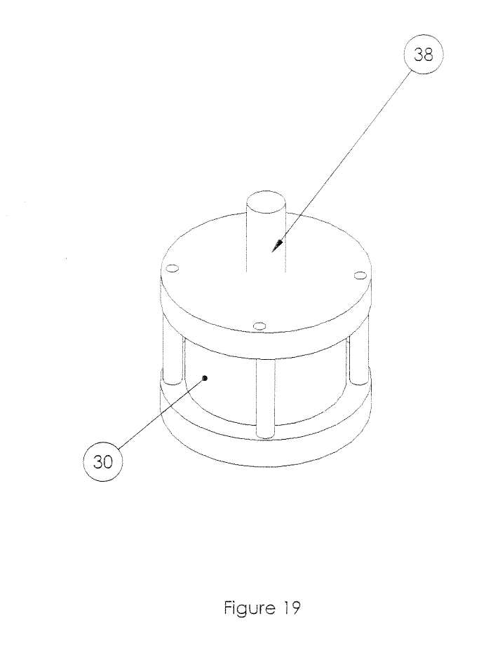

FIG. 17 shows a screen bed 35, which is comprised of front screen bed sections 32 and side screen bed sections 33, which make up an overall frame for the screen bed 35. FIG. 18 shows how each pneumatic cylinder holder cup 12 is braced by pneumatic cylinder holder support brackets 16, which are affixed to the screen bed sections 31, preferably by weld. FIG. 19 shows a pneumatic cylinder 30, which sits inside the pneumatic cylinder holder cup 12. The pneumatic cylinder piston 38 extends through the middle of the pneumatic cylinder holder cup 12 and is bolted to the clamp plate 21 of the screen carrier mounting bracket assembly 60.

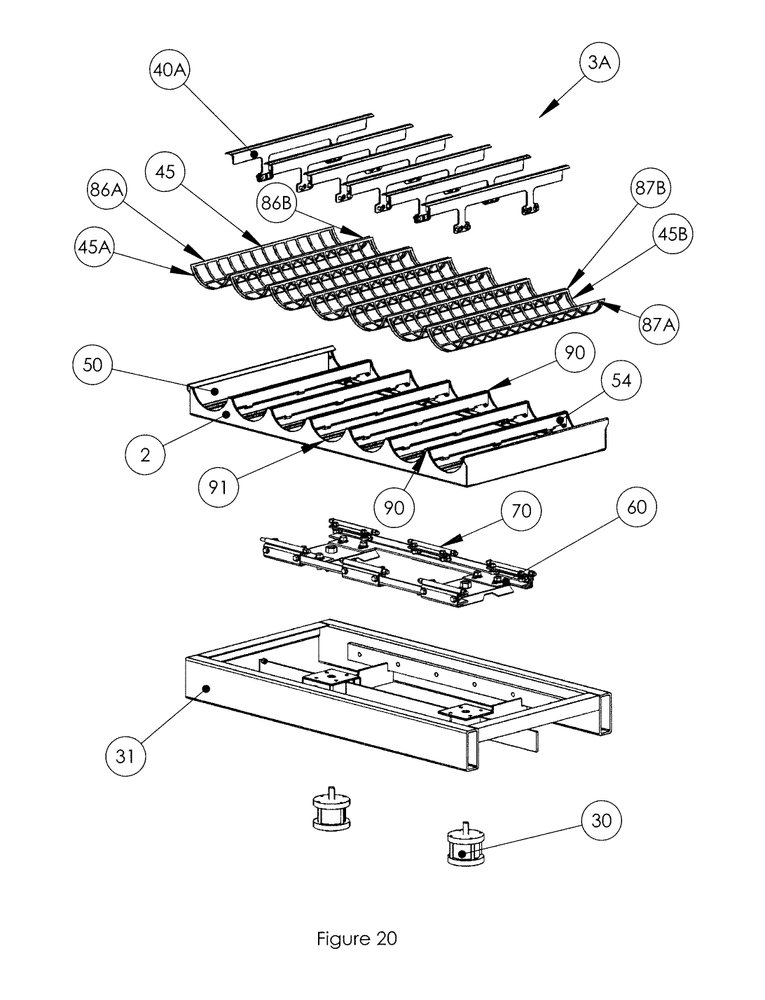

Turning to FIG. 20, an exploded screen bed assembly section 3A is shown with self-adjusting hold down bars 40A that are positioned through the hold down bar guides 54 of the carrier frame 50 and attached with the carrier frame mounting bracket 60 using tube brackets 70, as described in detail below. The screen bed 31 houses one or more pneumatic cylinders 30. The screen bed section 31 forms the base of the assembly 3A. Preferably two pneumatic cylinders 30 are connected to each screen bed section 31. A carrier frame mounting bracket assembly 60 is attached to the screen bed section 31 at the pneumatic cylinder 30 locations. The carrier frame mounting bracket assembly 60 is sandwiched between the carrier frame 50 and the screen bed 31, with the carrier frame 50 sitting on the screen bed 31.

The self-adjusting hold down bars 40A clamp or hold the plurality of screen elements 45 against the carrier frame 50 when in the closed position. Each of the screen elements 45 has opposing edges with a valley or trough between them, such as exemplary screen element 45A with opposing edges (86A, 86B), and screen element 45B with opposing edges (87A, 87B). Each of the two scallop plates 2 of the carrier frame 50 have a plurality of peaks 90 and valleys or troughs 91. The hold down bar guides 54 are disposed at the carrier frame peaks 90. Each screen element 45 rests in one of the carrier frame troughs 91, with each screen element edge adjacent to one of the peaks 90. Each curved screen element 45 may have a different radius. At a carrier frame peak 90 shared by two adjacent screen elements 45, the edges of the two screen elements located adjacent to the shared peak may be at different elevations and/or may not be parallel with each other. As discussed below, the self-adjusting hold down bars 40A accommodate this situation while still holding the screen elements 45 against the carrier frame 50 when in the closed position.

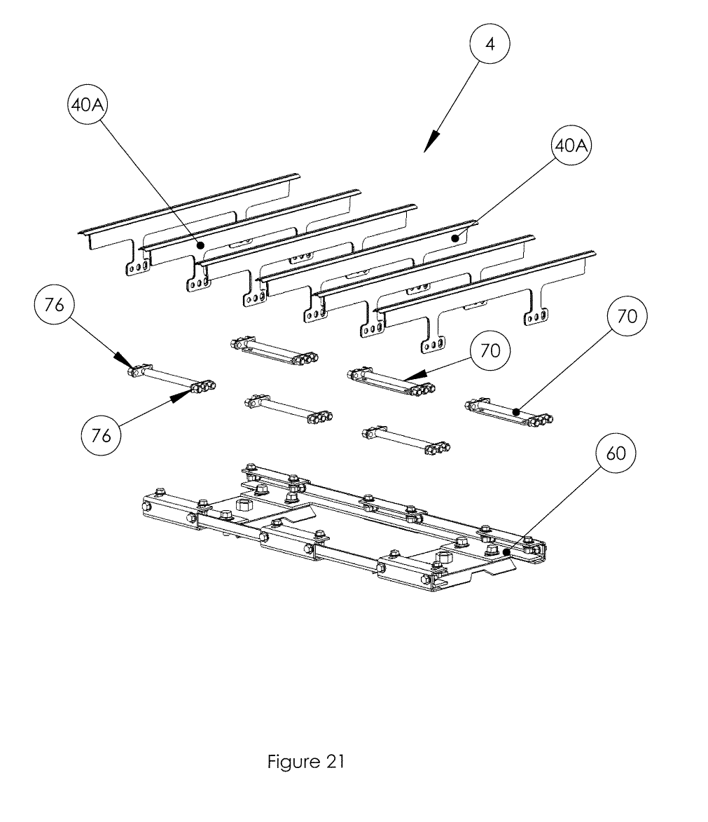

In FIG. 21, the exemplary hold down bar assembly system 4 includes the carrier frame mounting bracket assembly 60, a plurality of self-adjusting hold down bars 40A, and a plurality of tube brackets 70, each of which has two bolt brackets 76 attached. Each self-adjusting hold down bar 40A is paired with another self-adjusting hold down bar 40A that is adjacent to it, and the two hold down bars 40A are attached together using two tube brackets 70, which two tube brackets 70 are attached on opposite sides of the carrier frame mounting assembly 60.

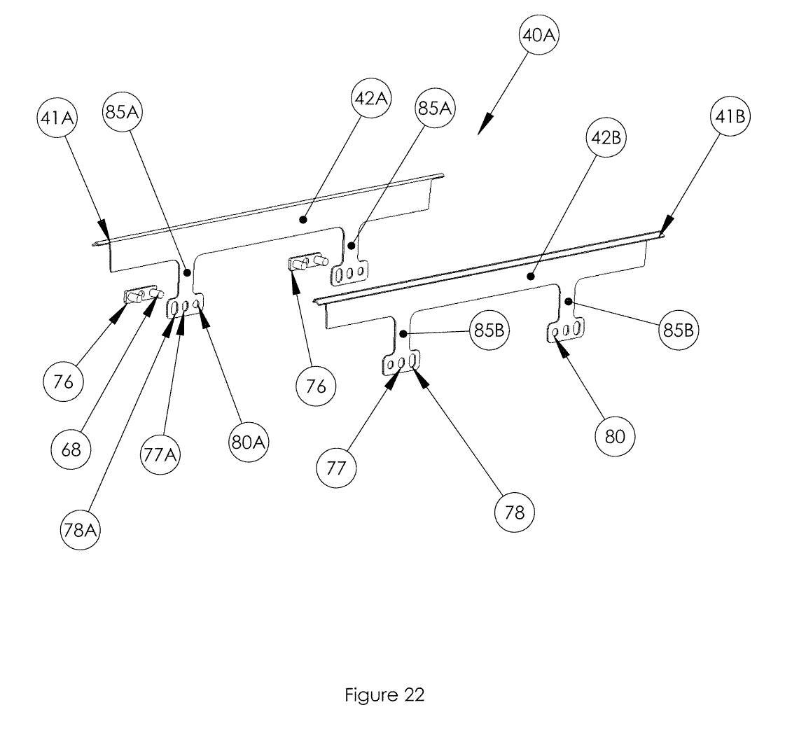

In FIG. 22, the assembly of a single self-adjusting hold down bar 40A is shown using two bolt brackets 76 and four locking hex nuts 74. A single adjustable hold down bar 40A comprises two metal plate sections (42A, 42B), each of which has a respective opposed hold down bar ledge (41A, 41B) that is used to contact an edge of an adjacent screen element 45 and hold the screen element 45 in place against the carrier frame 50 when the adjustable hold down bar 40A is in the closed position. Each bolt bracket 76 has two bolt bracket bolts 68. One bolt 68 is positioned through the outer hole 80A of the first plate section 42A and the outer slot 78 of the second plate section 42B. The other bolt 68 is positioned through the outer slot 78A of the first plate section 42A and the outer hole 80 of the second plate section 42B. One locking hex nut 74 may be disposed on the end of each bolt bracket bolt 68. The nuts 74 are not tightened against the second plate section 42B, so as to allow the first and second plate sections (42A, 42B) to move relative to each other. Other means of connection are also contemplated. Each set of adjacent three openings, such as openings (77, 78, 80) or openings (77A, 78A, 80A), are located at the base of their respective plate section (42A, 42B). Each base is located at the end of the respective legs 85A or 85B on the first plate section 42A or second plate section 42B.

The three openings may be of different sizes, such as circular for outer hole 80 and different length slots for center slot 77 and outer slot 78, with both slots (77, 78) having lengths greater than the diameter of the circular opening 80. Other shapes, sizes and relationships are also contemplated. Outer slot 78A of first plate 42A is aligned with outer hole 80 of second plate 42B. Although not shown, tube bracket bolt 75 is positioned through the center slots (77, 77A).

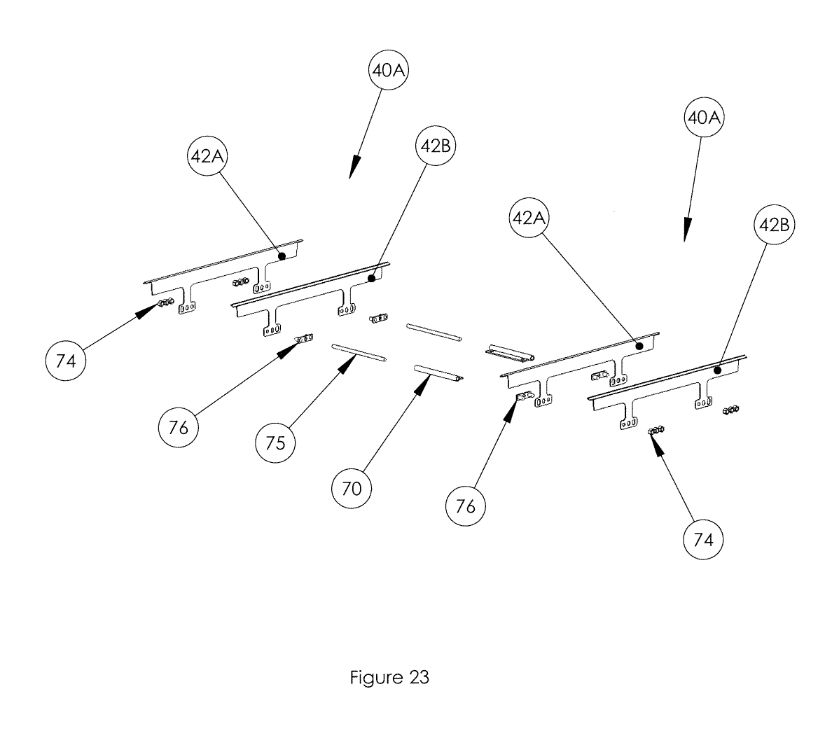

Turning to FIG. 23, an exemplary pair of self-adjusting hold down bars 40A may be connected together using two tube brackets 70. The opposed metal plate sections (42A, 42B) of each self-adjusting hold down bar 40A are each connected together with two bolt brackets 76 and four hex nuts 74. Tube bracket bolts 75 are positioned within tube brackets 70, and each bolt 75 is positioned through the center of the three openings at the base of the hold down bar 40A. A locking hex nut 74 may be disposed on the end of the tube bracket bolt 75. The center opening through which the tube bracket bolt extends is slotted to allow each pair of plate sections (42A, 42B) to move relative to each other. The pair of hold down bars 40A are attached together, and the bolt brackets 70 are attached on opposite sides of the mounting bracket assembly 60.

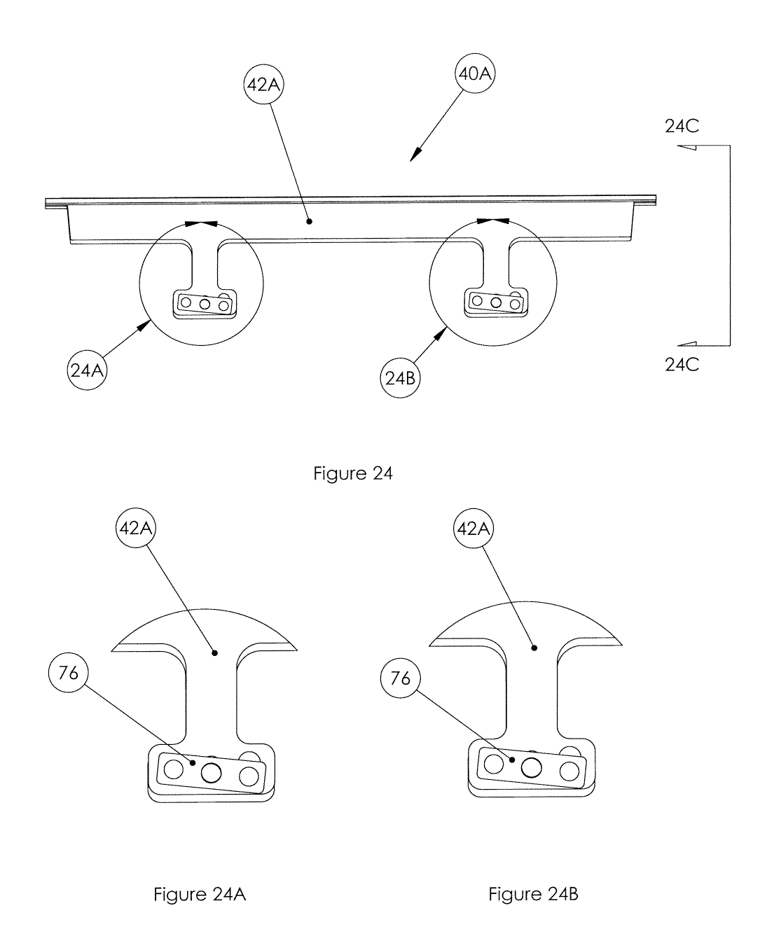

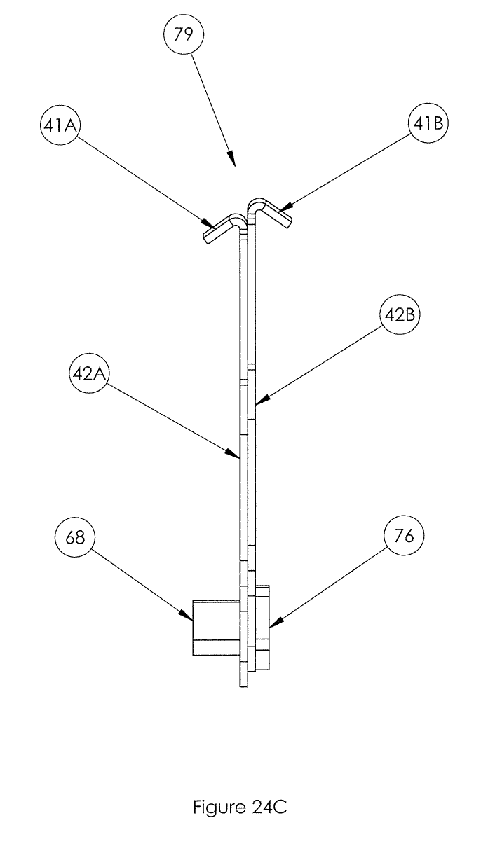

FIGS. 24-25B show how the self-adjusting hold down bars 40A accommodate adjacent screen elements 45 (not shown) resting on the carrier frame 50 that at a shared peak 90 of the carrier frame 50 have screen element edges that are parallel, but at different elevations. In FIGS. 24 and 25, the attached first plate 42A and second plate 42B of a single adjustable hold down bar 40A have shifted vertically relative to each other due to adjacent curved screen elements having edges at different elevations. The adjacent screen elements 45 have moved the first plate 42A and second plate 42B as shown. FIGS. 24A and 24B show how the two bolt brackets 76 through the hold down bar 40A have become angled from the uneven screen elements. The angle of the two bolt brackets 76 from horizontal is the same in FIGS. 24A and 24B since the edges of the two different screen elements are parallel.

The angle of the two bolt brackets 76 from horizontal shown in FIGS. 24A and 24B is shown for the maximum parallel offset 79 of the first plate 42A with the second plate 42B, which is shown in FIG. 24C. This corresponds with the maximum parallel offset of edges of adjacent parallel screen elements 45. The ledge 41A of first plate section 42A is at a first elevation and the ledge 41B of second plate section 42B is at a second elevation. The first elevation is different than the second elevation, and both elevations remain constant since the edges of the adjacent screen elements 45 are parallel. If the difference in elevation of the adjacent screen elements is smaller, then a smaller angle from horizontal for the bolt brackets 76 will be created for a smaller parallel offset 79. There will be no angle if the adjacent screen element edges are at the same elevation and no offset 79 required.

In FIGS. 25A and 25B, the bolt bracket bolts 68 extend through the second plate 42B of the hold down bar 40A. In FIG. 25B, it can be seen that the outside circular opening 80A of the first plate 42A is aligned with the outside slot 78 of the second plate 42B, which, along with the alignment of the other openings (78A, 80), allows for the bolt bracket 76 to self-adjust based upon the condition of the adjacent screen elements 45 (not shown). Although not shown, tube bracket bolt 75 is positioned through the center slots (77, 77A) for attachment of the hold down bar 40A with another hold down bar and the carrier frame mounting bracket assembly 60 using the tube bracket 70. The locking hex nut 74 on the end of the tube bracket bolt 75 is not tightened against the hold down bar 40A, and the center slots (77, 77A) allow the pair of metal plate sections (42A, 42B) to move relative to each other.

In one embodiment of a method, the screen elements 45 may be positioned on the troughs 91 of the carrier frame 50 with the adjustable hold down bars 40A in the upward position. The hold down bars 40A may then be lowered to the closed position. If two adjacent screen elements 45 have edges at a shared peak 90 of the carrier frame 50 that are parallel but at different elevations or heights, then the bolt brackets 76 will self-adjust to change the elevations of the hold down bar ledges (41A, 41B), similar to as shown in FIGS. 24-25B, to account for the difference in elevations. Each self-adjusting hold down bar will hold the two screen elements adjacent to it against the carrier frame. Other methods are also contemplated.

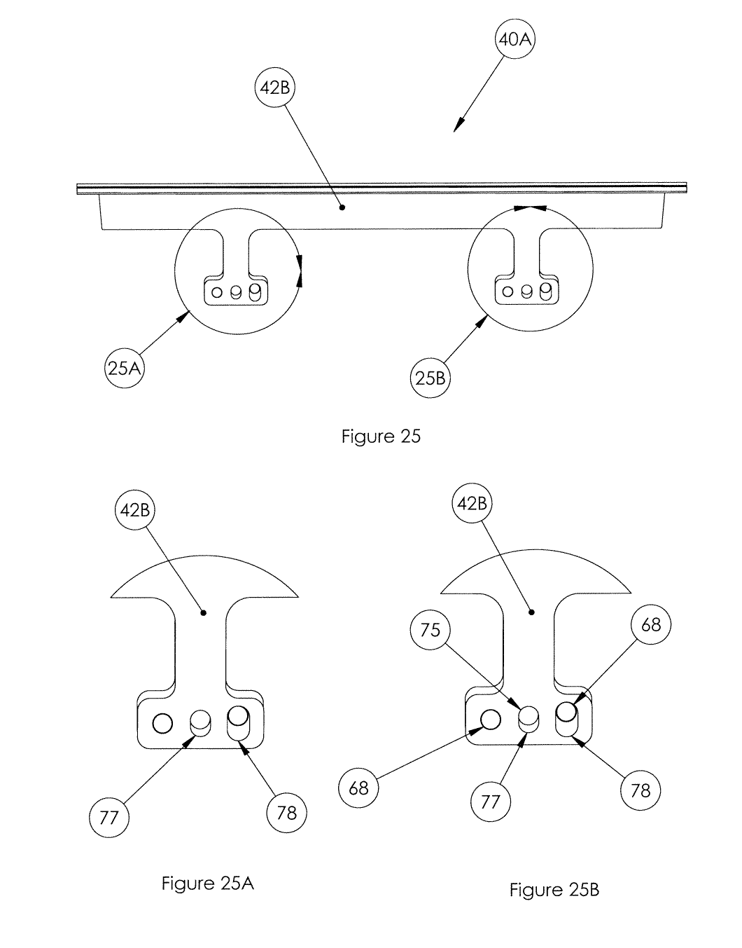

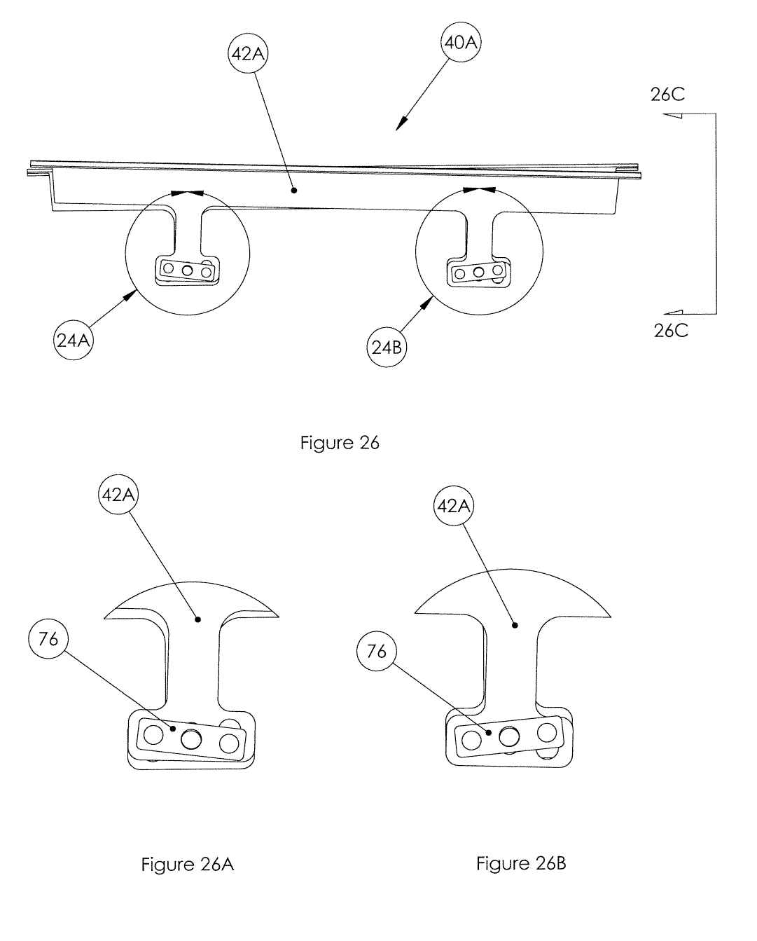

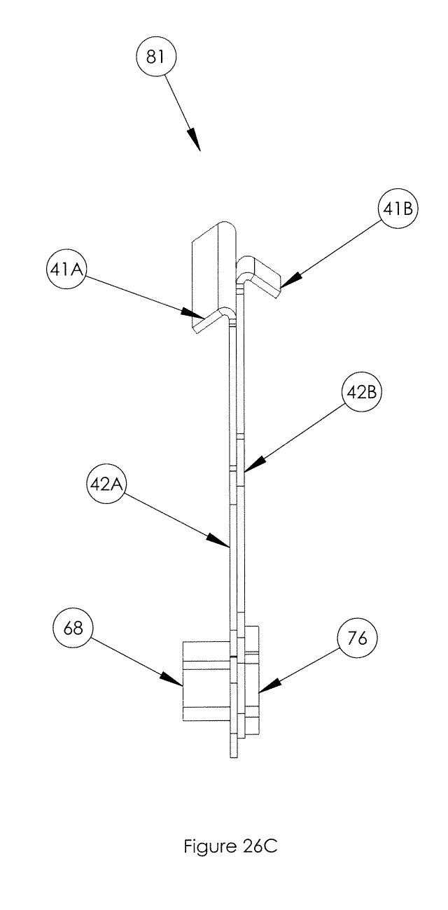

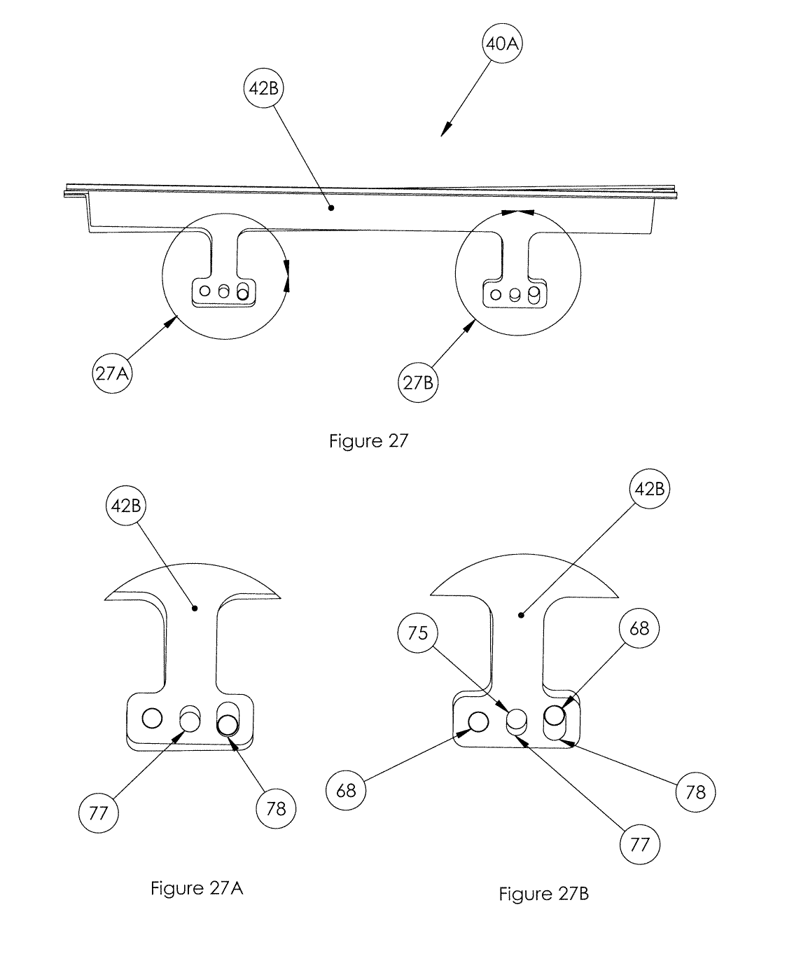

FIGS. 26-27B show how the self-adjusting hold down bars 40A accommodate adjacent screen elements 45 (not shown) resting on the carrier frame 50 that have screen element edges at a shared peak 90 of the carrier frame 50 that are not parallel. In FIGS. 26 and 27, the attached first plate 42A and second plate 42B of a single self-adjusting hold down bar 40A have shifted relative to each other due to adjacent curved screen elements having edges that are not parallel. The adjacent screen elements have moved the first and second plates (42A, 42B) as shown. FIGS. 26A and 26B show how the two bolt brackets 76 through the hold down bar 40A have become angled. The angle of the two bolt brackets 76 from horizontal is different in FIGS. 26A and 26B since the edges of the two different screen elements (not shown) are not parallel.

The difference in angle of the two bolt brackets 76 from horizontal shown in FIGS. 26A and 26B is for the maximum non-parallel offset 81 of the first plate 42A with the second plate 42B, which is shown in FIG. 26C. This corresponds with the maximum non-parallel offset of the edges of two adjacent screen elements. The ledge 41A of first plate section 42A is at a first elevation and the ledge 41B of second plate section 42B is at a second elevation. The first elevation is different than the second elevation, and both elevations are not necessarily constant since the edges of the adjacent screen elements 45 are not parallel. The bolt brackets 76 move independently to other angles and/or orientations for different non-parallel offset amounts.

In FIGS. 27A and 27B, the bolt bracket bolts 68 extend through the second plate 42B of the self-adjusting hold down bar 40A. In FIG. 27B, it can be seen that the outside circular opening 80A of the first plate 42A is aligned with the outside slot 78 of the second plate 42B, which, along with the alignment of the other openings (78A, 80), allows for the bolt bracket 76 to self-adjust based upon the condition of the adjacent screen elements 45 (not shown). Although not shown, tube bracket bolt 75 is positioned through the center slots (77, 77A) for attachment of the hold down bar 40A with another hold down bar and the carrier frame mounting bracket assembly 60 using the tube bracket 70.

In one embodiment of a method, the screen elements 45 may be positioned on the troughs 91 of the carrier frame 50 with the adjustable hold down bars 40A in the upward position. The hold down bars 40A may then be lowered to the closed position. If two adjacent screen elements 45 have edges at a shared peak 90 of the carrier frame 50 that are not parallel, then the bolt brackets 76 will self-adjust to change the elevations of the hold down bar ledges (41A, 41B), similar to as shown in FIGS. 26-27B, to account for the differences, while still holding the screen elements against the carrier frame 50. Other methods are also contemplated.

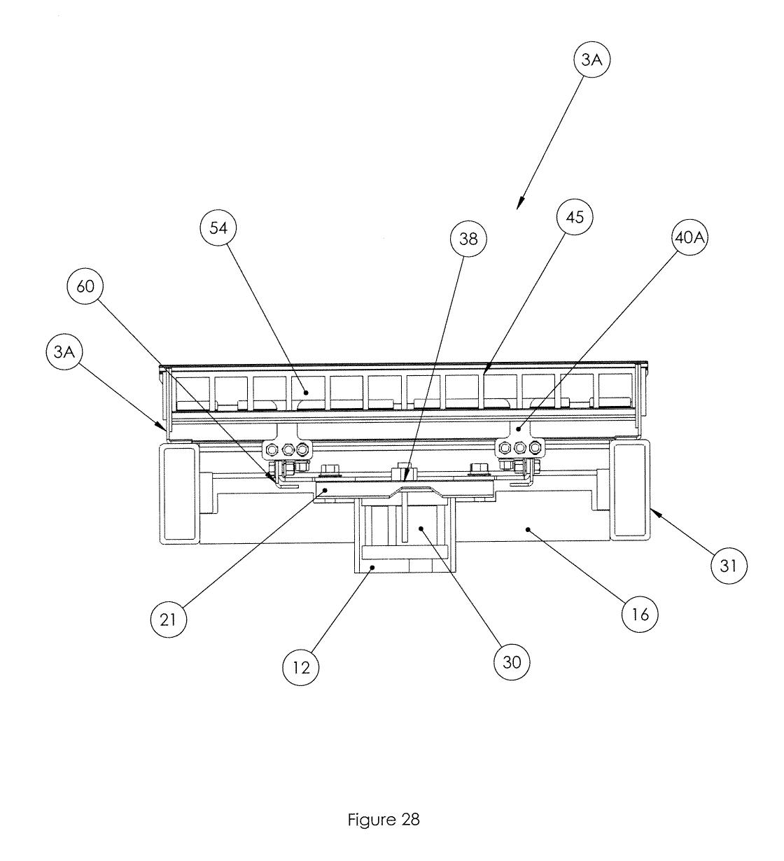

FIG. 28 shows a cross sectional view of the screen bed assembly section 3A when the hold down bars 40A are in a closed position. The screen bed section 31 contains pneumatic cylinder holder cups 12, which house pneumatic cylinders 30. The pneumatic cylinder holder cups 12 are supported and connected to the screen bed section 31 by pneumatic cylinder holder support brackets 16. The carrier frame mounting bracket assembly 60 attaches to the screen bed section 31 by bolting a clamp plate 21 to the piston 38 of a pneumatic cylinder 30. The carrier frame mounting bracket assembly 60 is then bolted to the hold down bars 40A, which are slid through guides 54 located between each screen element 45 in the carrier frame 50. The carrier frame 50 sits between the screen bed section 31 and the screen elements 45 that are clamped down by the hold down bars 40A. The carrier frame front scallop plate 2 sits on the screen bed section 31, and is also locked into place by the hold down bars 40A.

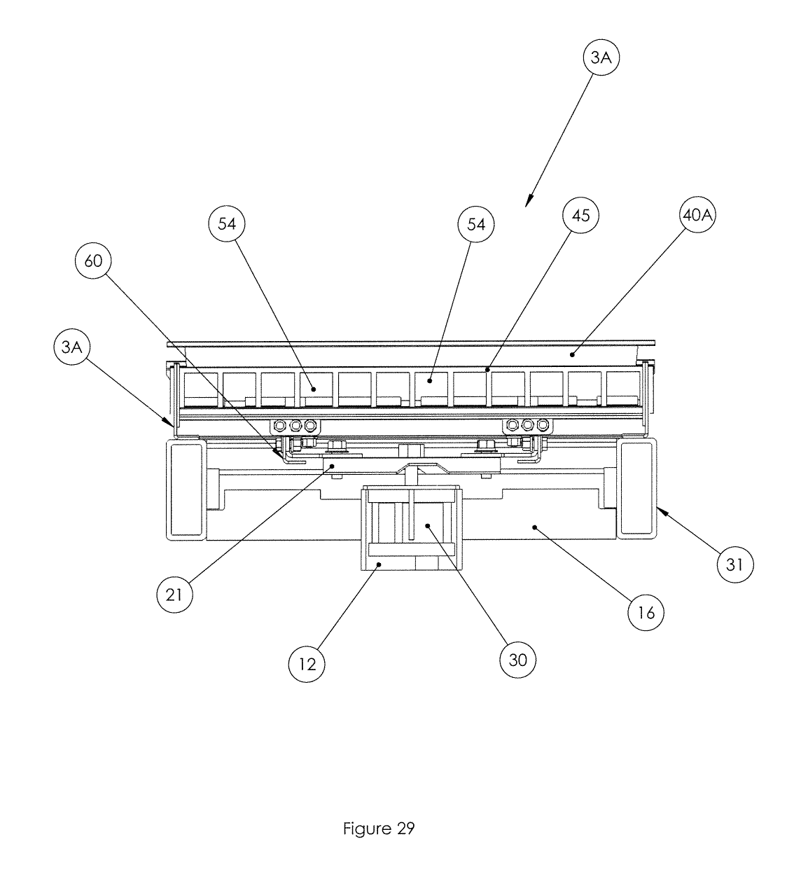

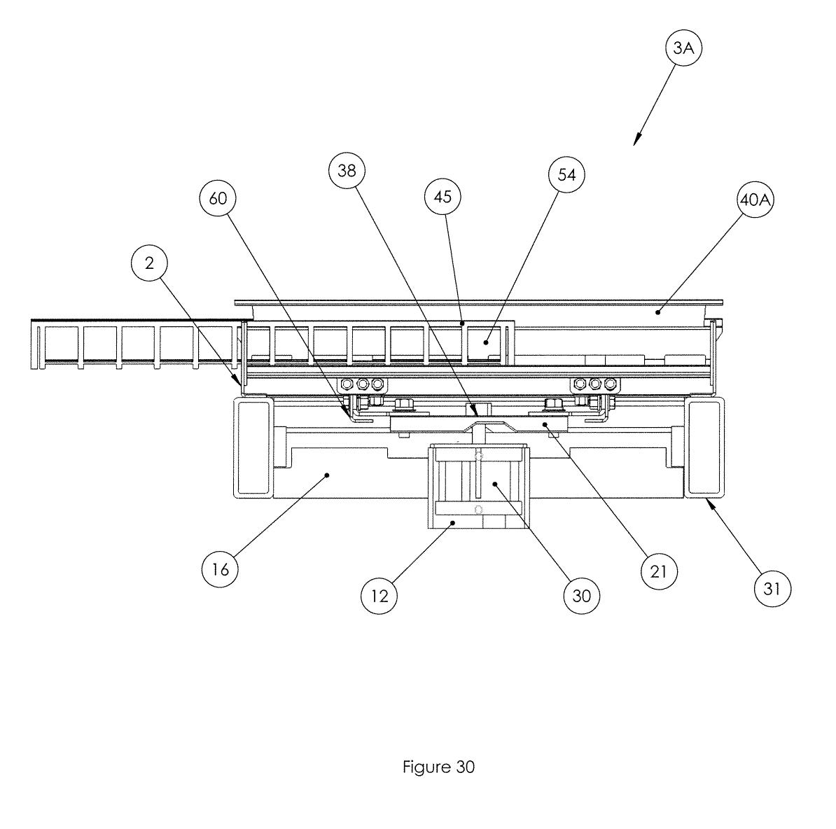

FIG. 29 is similar to FIG. 28, except that the hold down bar 40A is in an upward position. The hold down bar 40A is placed in an upward position when the pneumatic cylinder piston 38 of the pneumatic cylinder 30 is actuated and extends upward. When the hold down bar 40A is in an upward position, the screen elements 45 can easily be installed or removed. FIG. 30 shows the screen element 45 as it is moved either into or out of the screen bed assembly.

The foregoing disclosure and description of the invention is illustrative and explanatory thereof. Various changes in the details of the illustrated construction can be made within the scope of the present claims without departing from the true spirit of the invention. The invention should only be limited by the following claims and their legal equivalents.

I claim:

1. A system for curved screen elements in a mechanical shaker, comprising:
a first curved screen element having a first screen element trough between two first screen element edges;
a second curved screen element having a second screen element trough between two second screen element edges;
a screen bed that houses a pneumatic control device;
a carrier frame resting on said screen bed, wherein said carrier frame comprises a first curved support having a first support valley between a first peak and a second peak, and a second curved support having a second support valley between said second peak and a third peak;
a first hold down bar slidingly disposed through said carrier frame at said second peak of said carrier frame that is configured to be moved vertically by said pneumatic control device between a first position that does not resist the sliding movement of said screen elements into or away from said carrier frame, and a second position that resists movement of said screen elements from said carrier frame;
a second hold down bar slidingly disposed through said carrier frame at said third peak of said carrier frame that is configured to be moved vertically by said pneumatic control device; and
a carrier frame mounting bracket assembly positioned between said screen bed and said carrier frame, wherein said carrier frame mounting bracket assembly is connected to said hold down bars and said pneumatic control device;
wherein said first screen element trough is disposed over said carrier frame first support valley with one of said first screen element edges positioned adjacent to said second peak of said carrier frame;
wherein said second screen element trough is disposed over said carrier frame second support valley with one of said second screen element edges positioned adjacent to said second peak of said carrier frame;
wherein a first ledge of said first hold down bar is configured to contact said first screen element edge adjacent to said second peak of said carrier frame when said first hold down bar is in said second position;
wherein a second ledge of said first hold down bar is configured to contact said second screen element edge adjacent to said second peak of said carrier frame when said first hold down bar is in said second position; and
wherein said first hold down bar is configured to be adjusted by said first screen element and said second screen element when said first hold down bar is in said second position so as to allow said first ledge to move relative to said second ledge.

2. The system of claim 1, wherein first hold down bar and said second hold down bar are connected to each other with a tube bracket, and wherein said tube bracket is attached to said carrier frame mounting bracket assembly.

3. The system of claim 1, wherein said first ledge and second ledge are configured to be positioned offset to each other and parallel with each other when said first hold down bar is in said second position.

4. The system of claim 1, wherein said first hold down bar is configured to be self-adjusting so as to allow said first ledge to be at a different elevation than said second ledge when said first hold down bar is in said second position.

5. The system of claim 1, wherein said first ledge and second ledge are positioned not parallel with each other when said first hold down bar is in said second position.

6. The system of claim 1, wherein each of said hold down bars comprises a first metal plate connected with a second metal plate, and wherein said first plate has said first ledge and said second plate has said second ledge.

7. The system of claim 6, wherein said first and second metal plates are connected with a bolt bracket comprising a bolt bracket first bolt and a bolt bracket second bolt.

8. The system of claim 7, wherein said bolt bracket first bolt is disposed through a first opening in said first metal plate and a first opening in said second metal plate, wherein said bolt bracket second bolt is disposed through a second opening in said first metal plate and a second opening in said second metal plate, wherein said first metal plate first opening is smaller than said second metal plate first opening, and wherein said first metal plate second opening is larger than said second metal plate second opening.

9. The system of claim 1, wherein said first screen element edges and said second screen element edges are parallel; and wherein said first screen element edge adjacent to said second peak has an elevation that is different than said second screen element edge at said second peak.

10. The system of claim 1, wherein said first screen element edges and said second screen element edges are not parallel.

11. A method for curved screen elements in a mechanical shaker, comprising:
resting a carrier frame on a screen bed;
positioning a carrier frame mounting bracket assembly between said screen bed and said carrier frame, wherein said carrier frame mounting bracket assembly is connected to a plurality of hold down bars and a pneumatic control device;
sliding a first curved screen element having a first screen element trough over a first curved support of said carrier frame, wherein said first curved support has a first valley between a first peak and a second peak, and wherein said first screen element trough is between two first screen element edges;
positioning one of said first screen element edges adjacent to said second peak of said carrier frame;
sliding a second curved screen element having a second screen element trough over a second curved support of a carrier frame, wherein said second curved support has a second support valley between said second peak and a third peak, and wherein said second screen element trough is between two second screen element edges;
positioning one of said second screen element edges positioned adjacent to said second peak of said carrier frame;
moving a first hold down bar downward with said pneumatic control device, wherein said first hold down bar is slidingly disposed through said carrier frame at said second peak of said carrier frame;
moving a second hold down bar downward with said pneumatic control device, wherein said second hold down bar is slidingly disposed through said carrier frame at said third peak of said carrier frame, and wherein said first and second hold down bars are connected together;
holding said first screen element against said carrier frame with a first ledge of said first hold down bar;
holding said second screen element against said carrier frame with a second ledge of said first hold down bar; and
adjusting said first ledge and said second ledge by said first screen element and said second screen element to account for a difference between said first screen element and said second screen element during said step of moving said first hold down bar downward.

12. The method of claim 11, wherein said edges of said first and second screen elements adjacent to said second peak are at different elevations.

13. The method of claim 11, wherein said first ledge and said second ledge are parallel.

14. The method of claim 11, wherein said first ledge and said second ledge are not parallel.

15. The method of claim 11, further comprising the steps of:
moving said first hold down bar upward with said pneumatic control device; and
sliding said first curved screen element away from said carrier frame.

16. The method of claim 11, wherein said first hold down bar comprises a first metal plate connected with a second metal plate with a bolt bracket, and further comprising the step of:
self-adjusting said first ledge and said second ledge with said bolt bracket during said step of moving said first hold down bar downward.

17. The method of claim 16, wherein said bolt bracket comprises a first bolt and a second bolt, and further comprising the steps of:
moving said first bolt through a first opening in said first metal plate and a first opening in said second metal plate; and
moving said second bolt through a second opening in said first metal plate and a second opening in said second metal plate;
wherein said first metal plate first opening is smaller than said second metal plate first opening, and wherein said first metal plate second opening is larger than said second metal plate second opening.

18. A apparatus for curved screen elements in a mechanical shaker, comprising:
a screen bed that houses a pneumatic control device;
a carrier frame resting on said screen bed, wherein said carrier frame comprises a first curved support having a first support valley between a first peak and a second peak, and a second curved support having a second support valley between said second peak and a third peak; and
a hold down bar configured to be moved vertically by said pneumatic control device, wherein said first hold down bar is slidingly disposed through said carrier frame at said second peak of said carrier frame;
wherein said hold down bar is configured to hold a first curved screen element against said carrier frame with a first ledge and to hold a second curved screen element against said carrier frame with a second ledge when said hold down bar is in a downward position; and
wherein said first ledge and said second ledge are configured to be adjusted by said first screen element and said second screen element when said hold down bar is in said downward position to account for a difference between said first screen element and said second screen element when said first screen element and said second screen element are positioned adjacent to said second peak of said carrier frame.

19. The apparatus of claim 18, wherein said first ledge and said second ledge are configured to be moved relative to each other by said first screen element and said second screen element.

20. The system of claim 18, wherein said first ledge and said second ledge are configured to be adjusted into positions not parallel to each other.
